(19) United States
(12) Patent Application Publication
(10) Pub. No.: US 2010/0104333 A1
(43) Pub. Date: Apr. 29, 2010

(54) HEATING ROLLER AND IMAGE FORMING APPARATUS

(75) Inventors: Yoshinori TSUEDA, Shizuoka-ken (JP); Osamu TAKAGI, Tokyo (JP); Satoshi KINOUCHI, Tokyo (JP); Toshihiro SONE, Kanagawa-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/580,134

(22) Filed: Oct. 15, 2009

Related U.S. Application Data
(60) Provisional application No. 61/109,458, filed on Oct. 29, 2008.

(51) Int. Cl. G03G 15/20; F28F 5/02

(52) U.S. Cl. 399/333; 492/46

(57) ABSTRACT

The present invention provides a technique that can contribute to the improvement of fixing performance while maintaining appropriate nip width. A heating roller includes: a core configured to rotate around a predetermined rotation axis; plural elastic layers laminated on the outer circumference of the core; and a conductive layer formed on the outer circumference of the plural elastic layers. The plural elastic layers have, in a rotation radius direction, larger specific heat in the elastic layer on the outer side than in the elastic layer on the inner side and have lower thermal conductivity in the elastic layer on the inner side than in the elastic layer on the outer side.

### CROSS-REFERENCE TO RELATED APPLICATION

This application is based upon and claims the benefit of priority from: U.S. provisional application 61/109458, filed on Oct. 29, 2008, the entire contents of each of which are incorporated herein by reference.

### TECHNICAL FIELD

This specification relates to a technique for heating and fixing a developer image on a sheet, and, more particularly to a technique for suppressing occurrence of a fixing failure.

### BACKGROUND

In the past, in an image forming apparatus such as an electronic copying machine, there is known a fixing technique for pressing a sheet having a developer image formed thereon while heating the sheet to thereby fix the developer image on the sheet.

In the fixing technique, a heating roller that melts a developer (e.g., a toner) and a pressing roller pressed against the heating roller with predetermined pressure are used. A developer image on a sheet, which is nipped and carried by a contact area (a nip) of the heating roller and the pressing roller, is melted by heat from the heating roller. The developer image on the sheet is fixed by the pressure between the heating roller and the pressing roller.

In the past, there is known a roller that is excellent in heat insulating properties and quick in temperature rise by heating and has elasticity and a heating device employing the roller (see, for example, JP-A-2002-295452).

There is also known a technique for forming sufficiently large nip width as contact length between a heating roller and a pressing roller in a sheet conveying direction. In this technique in the past, a non-offset area is set wide. The non-offset area is a range of heating temperature in which a high-quality fixed image can be obtained with a toner sufficiently fused on a sheet and never peeled off (see, for example, JP-A-2002-213434).

In recent years, there is known a fixing technique using a heating roller having an elastic layer provided in the outer circumference of a core in order to secure wider nip width and a conductive layer of a thin film formed on the outer side of this elastic later. Heating and fixing of a developer image on a sheet is performed by heating the conductive layer using induction heating.

When the heating roller having this configuration is used in an image forming apparatus having high printing speed, it is necessary to increase a heat capacity of the heating roller to some extent in order to prevent a sudden fall in the temperature of the heating roller during continuous feed. As a method of increasing the heat capacity of the heating roller, for example, there is a method of increasing the thickness of the conductive layer. However, when this method is used, the hardness of the heating roller is higher than necessary. When it is attempted to secure necessary nip width, appropriate nipping pressure for heating and fixing a developer image on a sheet may not be able to be maintained.

### SUMMARY

In order to solve the problems, this specification relates to a heating roller including: a core configured to rotate around a predetermined rotation axis; plural elastic layers laminated on the outer circumference of the core; and a conductive layer formed on the outer circumference of the plural elastic layers, wherein the plural elastic layers have, in a rotation radius direction, larger specific heat in the elastic layer on the outer side than in the elastic layer on the inner side and have lower thermal conductivity in the elastic layer on the inner side than in the elastic layer on the outer side.

The specification relates to an image forming apparatus including: a heating roller having the configuration explained above; a pressing roller configured to nip and carry a sheet having a toner image formed thereon and heat and fix the toner image on the sheet in cooperation with the heating roller; and a discharge roller configured to discharge the sheet having the toner image heated and fixed thereon to a predetermined discharge position.

### DESCRIPTION OF THE DRAWINGS

FIG. 1 is a longitudinal sectional view of a configuration of an image forming apparatus according to a first embodiment of the present invention;

FIG. 2 is a diagram of an example of a configuration of a fixing device in the image forming apparatus according to the first embodiment;

FIG. 3 is a sectional view on a vertical plane including a rotation axis direction of a heating roller included in the fixing device shown in FIG. 2; and

FIG. 4 is a sectional view of a configuration of a fixing device and a heating roller included in an image forming apparatus including the fixing device according to a third embodiment of the present invention.

### DETAILED DESCRIPTION

Embodiments of the present invention are explained below with reference to the accompanying drawings.

### First Embodiment

First, a first embodiment of the present invention is explained.

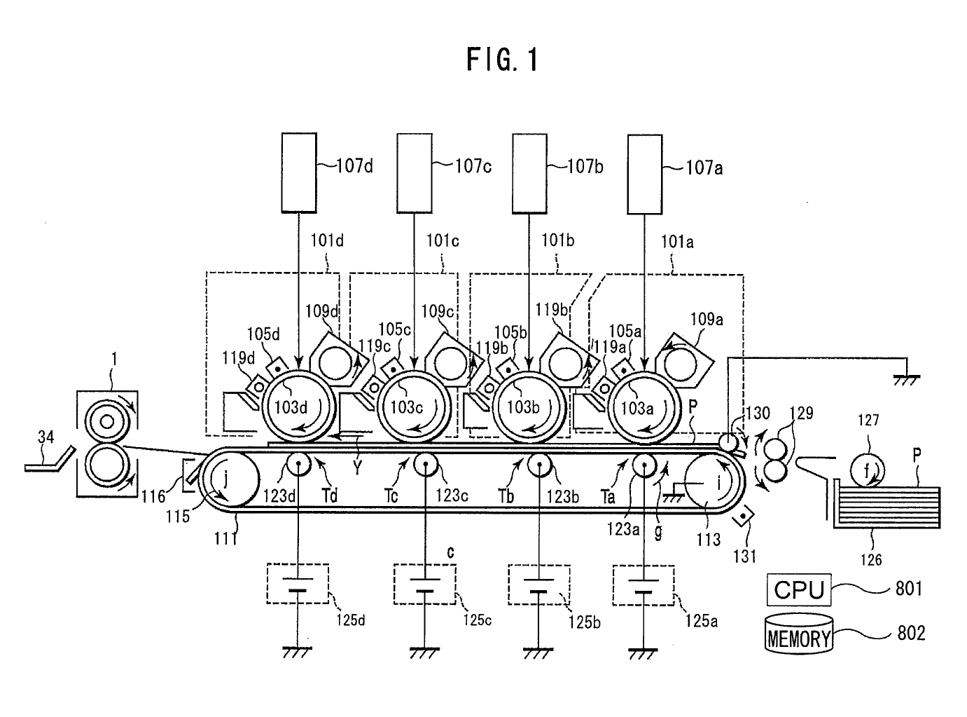

FIG. 1 is a longitudinal sectional view of a configuration of an image forming apparatus (MFP: Multi Function Peripheral) according to the first embodiment. The image forming apparatus according to this embodiment is a quadruple tandem color image forming apparatus.

As shown in FIG. 1, an image forming apparatus according to this embodiment includes process units 101a, 101b, 101c, and 101d. Developers of yellow (Y), magenta (M), cyan (C), and black (Bk) are respectively applied to the process units 101a to 101d. Each of the process units 101a to 101d is detachably attachable to an image forming apparatus main body. The process units 101a to 101d respectively include photoconductive drums 103a, 103b, 103c, and 103d as image bearing members. Developer images are formed in photoconductive areas formed on the outer circumferential surfaces of the photoconductive drums 103a to 103d.

Specifically, the photoconductive drums 103a to 103d have the photoconductive areas, the potentials of which are changed by the irradiation of light, on the outer circumferential surfaces thereof. Image areas and non-image areas having potentials different from each other are formed in the photoconductive areas of the photoconductive drums 103a to 103d. In this embodiment, as an example, the photoconductive drums are adopted as the image bearing members. However, the image bearing members are not limited to the photoconductive drums. Photoconductive belts can also be adopted.

Exposing devices 107a, 107b, 107c, and 107d that respectively expose the photoconductive drums 103a to 103d with laser beams, the light emission intensity of which is controlled according to an image signal supplied from, for example, a CPU 801, are respectively arranged near the process units 101a to 101d.

The laser beams output from the exposing devices 107a to 107d can have predetermined light intensity corresponding to, for example, the density of an image. As a light source for the exposing devices 107a to 107d, an LED can be adopted instead of a laser.

A conveyor belt (a conveying unit) 111 that conveys a sheet (a transfer medium) P as an image formation medium is provided on a side of the process units 101a to 101d opposed to the photoconductive drums 103a to 103d. The sheet P is conveyed in an arrow Y direction by the conveyor belt 111 and brought into contact with developer images formed on the photoconductive drums 103a to 103d.

The conveyor belt 111 has length (width) substantially equal to a length dimension of the photoconductive drum 103a in a direction orthogonal to the conveying direction Y of the sheet P (a depth direction in the figure or a longitudinal direction of the photoconductive drum). The conveyor belt 111 is an endless (seamless) belt and is wound and suspended on a driving roller 115 and a driven roller 113 that rotationally move the conveyor belt ill at predetermined speed. A distance from the driving roller 115 to the driven roller 113 is about 300 mm. The driving roller 115 and the driven roller 113 are respectively provided rotatably in an arrow j direction and an arrow i direction shown in the figure. According to the rotation of the driving roller 115, the conveyor belt 111 rotates and the driven roller 113 is driven to rotate. Sufficient tension is applied to the conveyor belt 111 by adjusting the inter-axis distance between the driving roller 115 and the driven roller 113 to prevent the conveyor belt 111 from slipping on the driving roller 115 and the driven roller 113.

The process unit 101a is explained below. The process unit 101a includes the photoconductive drum 103a, an electrifying charger 105a, a developing device 109a, and a charge removing lamp 119a.

In the photoconductive area on the outer circumferential surface of the photoconductive drum 103a, the potential of an area on which light is irradiated changes according to the irradiation of the light in a state in which predetermined potential is applied thereto. The photoconductive area can maintain a change in the potential, which is caused by the irradiation of the light, as an electrostatic image for predetermined time. The photoconductive drum 103a is formed in, for example, a cylindrical shape having a diameter of 30 mm and is provided rotatably in an arrow direction shown in the figure (clockwise). The charge removing lamp 119a, the electrifying charger 105a, and the developing device 109a are arranged around the photoconductive drum 103a along a rotating direction thereof.

The electrifying charger 105a is provided to be opposed to the surface of the photoconductive drum 103a and uniformly charges the photoconductive drum 103a. As the electrifying charger 105a, a corona wire, a contact roller, a contact blade, or the like can also be adopted. A laser beam from the exposing device 107a is irradiated further on a downstream side than the electrifying charger 105a in a moving direction of a photoconductive surface of the photoconductive drum 103a and further on an upstream side than the developing device 109a in the moving direction to expose the photoconductive surface. An electrostatic latent image is formed on the surface of the photoconductive drum 103a, which is charged by the electrifying charger 105a, by the exposure by the exposing device 107a.

The developing device 109a stores a yellow developer. The developing device 109a is arranged further on the downstream side than a position of exposure by the exposing device 107a in the moving direction of the photoconductive surface of the photoconductive drum 103a. The developing device 109a supplies the yellow developer to an image portion of the electrostatic latent image on the photoconductive drum 103a formed by the exposing device 107a and forms a developer image.

The charge removing lamp 119a is arranged further on the downstream side than a contact position between the photoconductive drum 103a and the sheet P in the moving direction of the photoconductive surface of the photoconductive drum 103a. The charge removing lamp 119a has a role of removing the surface charge of the photoconductive drum 103a with uniform light irradiation after the developer image on the photoconductive drum 103a is transferred onto the sheet P. One cycle of image forming processing is completed by charge removing processing by the charge removing lamp 119a. When the next image forming process is started, the electrifying charger 105a uniformly charges the uncharged photoconductive surface of the photoconductive drum 103a again.

Besides the process unit 101a, the process units 101b, 101c, and 101d are arranged between the driving roller 115 and the driven roller 113 on the conveyor belt 111 along the conveying direction of the sheet P.

All the process units 101b to 101d are configured the same as the process unit 101a. Specifically, the photoconductive drums 103b, 103c, and 103d are respectively arranged substantially in the centers of the process units 101b to 101d. The electrifying chargers 105b, 105c, and 105d are respectively provided around the photoconductive drums 103b, 103c, and 103d. Positions of exposure by the exposing devices 107b, 107c, and 107d are respectively located downstream of the electrifying chargers 105b to 105d in the moving direction of the photoconductive surfaces of the photoconductive drums. The developing devices 109b, 109c, and 109d and the charge removing lamps 119b, 119c, and 119d are respectively provided further on the downstream side than the exposing positions in the moving direction of the photoconductive surfaces of the photoconductive drums.

In the process units 101b to 101d, colors of developers stored in the developing devices 109b to 109d are different. A magenta developer is stored in the developing device 109b, a cyan developer is stored in the developing device 109c, and a black developer is stored in the developing device 109d.

The sheet P conveyed by the conveyor belt 111 is conveyed while sequentially coming into contact with the photoconductive drums 103a to 103d. Transfer devices 123a, 123b, 123c, and 123d are provided to respectively correspond to the photoconductive drums 103a to 103d near contact positions between the sheet P conveyed by the conveyor belt 111 and the photoconductive drums 103a to 103d. Specifically, the transfer devices 123a to 123d are provided in back-contact with the inner circumferential side of the conveyor belt 111 below the photoconductive drums 103a to 103d corresponding thereto, respectively. The transfer devices 123a to 123d are respectively opposed to the process units 101a to 101d via the conveyor belt 111. Transfer areas Ta, Tb, Tc, and Td are respectively defined in positions where the transfer devices 123a to 123d and the photoconductive drums 103a to 103d are respectively opposed to each other via the conveyor belt 111. In the transfer areas Ta, Tb, Tc, and Td, toner images are respectively transferred onto the sheet P from the photoconductive drums 103a to 103d.

The transfer device 123a is connected to a DC power supply 125a. Similarly, the transfer devices 123b, 123c, and 123d are respectively connected to DC power supplies 125b, 125c, and 125d. When the sheet P reaches the transfer area Ta, the transfer device 123a is applied with transfer bias voltage from the DC power supply 125a. Consequently, a transfer electric field is formed between the transfer device 123a and the photoconductive drum 103a. A yellow toner image on the photoconductive drum 103a is transferred onto the sheet P according to the transfer electric field.

When the sheet P reaches the transfer area Tb, the transfer device 123b is applied with transfer bias voltage, which is higher than the transfer bias voltage from the DC power supply 125a, by the DC power supply 125b. This makes it possible to transfer a magenta toner image to be superimposed on the yellow toner image.

When the sheet P reaches the transfer area Tc, the transfer device 123c is applied with transfer bias voltage, which is higher than the transfer bias voltage from the DC power supply 125b, by the DC power supply 125c. This makes it possible to transfer a cyan toner image to be superimposed on the magenta toner image.

When the sheet P reaches the transfer area Td, the transfer device 123d is applied with transfer bias voltage, which is higher than the transfer bias voltage from the DC power supply 125c, by the DC power supply 125d. This makes it possible to transfer a black toner image to be superimposed on the cyan toner image.

In this way, voltage higher than transfer bias voltage used during transfer of an already-transferred toner image is applied to the transfer device. This makes it possible to transfer the next toner image to be superimposed on the toner image.

In FIG. 1, a paper feeding cassette 126 that stores sheets P is provided on the right in the front of the conveyor belt 111. In the image forming apparatus main body, a pickup roller 127 that picks up the sheets P from the paper feeding cassette 126 one by one is provided to be rotatable in an arrow f direction in the figure. A registration roller pair 129 is rotatably provided between the pickup roller 127 and the conveyor belt 111. The registration roller pair 129 supplies the sheet P onto the conveyor belt ill at predetermined timing.

A metal roller 130 for electrostatically attracting the sheet P to the surface of the conveyor belt 111 is arranged on the conveyor belt 111. The metal roller 130 is grounded (earthed).

In order to attract the sheet P to the conveyor belt 111 by charging the conveyor belt 111, with the driven roller 113 of the conveyor belt 111 set as a counter electrode, a corona charger 131 is set below the driven roller 113 via the conveyor belt 111.

On the other hand, in FIG. 1, a fixing device 1 that fixes developers transferred by the process units 101a to 101d on the sheet P and a paper discharge tray 34 to which the sheet P having the developers fixed thereon by the fixing device 1 is discharged are provided on the left in the front of the conveyor belt 111.

The image forming apparatus according to this embodiment includes the CPU 801 and a memory 802.

The CPU 801 has a role of performing various kinds of processing in the image forming apparatus and also has a role of realizing various functions by executing computer programs stored in the memory 802. The memory 802 can include, for example, a RAM (Random Access Memory), a ROM (Read Only Memory), a DRAM (Dynamic Random Access Memory), a SRAM (Static Random Access Memory), or a VRAM (Video RAM). The memory 802 has a role of storing various kinds of information and programs used in the image forming apparatus.

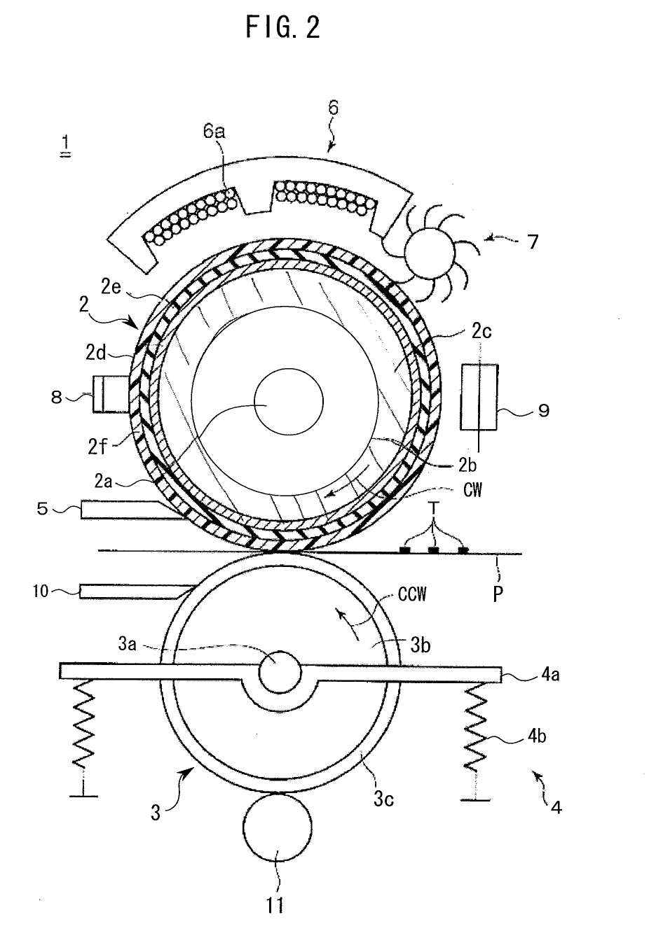

FIG. 2 is a diagram of an example of a configuration of the fixing device 1 in the image forming apparatus according to the first embodiment.

As shown in FIG. 2, the fixing device 1 includes a heating roller 2 (a heating member) that heats and melts a toner T transferred on the sheet P and a pressing roller 3 (a pressing member) that comes into press-contact with the heating roller 2 with predetermined pressing force and nips and carries the sheet P in cooperation with the heating roller 2.

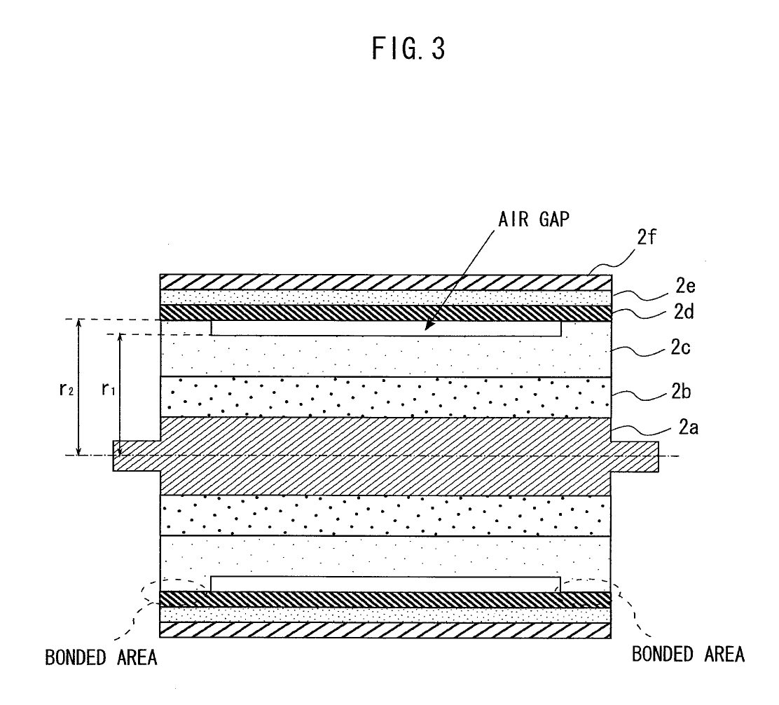

FIG. 3 is a sectional view on a vertical plane including a rotation axis direction of the heating roller 2 included in the fixing device 1 shown in FIG. 2.

The pressing roller 3 includes a shaft member 3a, an elastic member (e.g. , silicon rubber) 3b arranged on the outer side of the shaft member 3a, and a release layer (e.g., fluorine rubber) 3c.

The pressing roller 3 is rotated in an arrow CCW direction by a not-shown driving motor. The heating roller 2 is rotated in an arrow CW direction following the rotation of the pressing roller 3.

A pressing mechanism 4 presses the pressing roller 3 against the heating roller 2 with a pressing spring 4b via a member 4a connected to the shaft member 3a. Consequently, a nip having fixed or larger width (nip width) in the conveying direction of the sheet P is formed in a contact section between the heating roller 2 and the pressing roller 3.

Around the heating roller 2, in the rotating direction of the heating roller 2, a peeling blade 5 for peeling the sheet P from the heating roller 2, an induction heating device 6 that includes an excitation coil 6a and generates a predetermined eddy current in a metal conductive layer 2d of the heating roller 2, and a cleaning member 7 for removing an offset toner and dust such as paper powder adhering to the heating roller 2 are arrayed further on the downstream side than the nip of the heating roller 2 and the pressing roller 3.

In the rotation axis direction (the longitudinal direction) of the heating roller 2, a thermistor 8 that detects the temperature on the roller surface of the heating roller 2 and a thermostat 9 for stopping power supply to the heating roller 2 when abnormality of the surface temperature of the heating roller 2 is detected are arrayed. It is preferable to arrange plural thermistors 8 in the longitudinal direction of the heating roller 2. It is preferable to arrange at least one thermostat 9 in the longitudinal direction of the heating roller 2.

Around the pressing roller 3, a peeling blade 10 for peeling the sheet P from the pressing roller 3 and a cleaning member 11 for removing a toner adhering to the pressing roller 3 are arranged.

When a high-frequency current is supplied from an excitation circuit (an inverter circuit) to the excitation coil 6a of the induction heating device 6, a predetermined magnetic field is generated from the excitation coil 6a. An eddy-current flows to the metal conductive layer 2d of the heating roller 2 shown in FIG. 3. Then, Joule heat is generated by the resistance of the metal conductive layer 2d and the heating roller 2 generates heat.

The toner T melted by the heat generated by the heating roller 2 in this way is fixed on the sheet P when the sheet P, to which the toner T adheres, passes through the nip of the heating roller 2 and the pressing roller 3 and is applied with predetermined pressure by the pressing roller 3.

Since the fixing device 1 according to this embodiment causes, making use of the induction heating phenomenon, the metal conductive layer 2d included in the heating roller 2 to generate heat, a heat loss is small in the fixing device 1. Therefore, the fixing device 1 according to this embodiment can heat up the heating roller 2 in short time with high energy efficiency.

A configuration of the heating roller 2 is explained in detail below.

The heating roller 2 includes a shaft member (a core) 2a, a first elastic layer 2b, a second elastic layer 2c, the metal conductive layer 2d (a conductive layer), a third elastic layer 2e, and a release layer 2f arranged around the shaft member 2a.

In this embodiment, the first elastic layer 2b (an elastic layer located on the innermost side in a rotation radius direction thereof) is formed of foaming silicon rubber obtained by causing silicon rubber or the like to foam.

The second elastic layer 2c (an elastic layer located on the outermost side in the rotation radius direction among the plural elastic layers located between the core 2a and the metal conductive layer 2d) is formed of non-foaming silicon rubber (hereinafter referred to as solid rubber), foaming rubber with a foaming ratio set lower and density set higher than those of the first elastic layer 2b, or the solid rubber or the foaming rubber added with a filler such as carbon or metal to improve a heat capacity and thermal conductivity per unit volume.

In this embodiment, the second elastic layer 2c is formed to have the density higher (the heat capacity larger) than that of the first elastic layer 2b. Consequently, the second elastic layer 2c has a high heat capacity compared with the first elastic layer 2b.

As shown in FIG. 3, the second elastic layer 2c is formed such that an outer diameter in the center in the rotation axis direction (a radius r1 in FIG. 3) is small compared with an outer diameter at an end in the rotation axis direction (a radius r2 in FIG. 3).

The metal conductive layer 2d is formed of aluminum, nickel, iron, or the like having thickness of about 30 μm to 100 μm.

The third elastic layer 2e is formed of solid silicon rubber having thickness of about 200 μm.

As explained above, in this embodiment, the elastic layer located on the outermost side in the rotation radius direction among the plural elastic layers is formed of foaming silicon rubber having a foaming ratio lower than that of the elastic layer located further on the inner side in the rotation radius direction than the elastic layer located on the outermost side in the rotation radius direction.

The release layer 2f is formed with thickness of about 30 μm in an outermost circumferential portion of the heating roller 2. Specifically, the release layer 2f is formed of fluorine resin (PFA or PTFE (polytetrafluoroethylene), or a mixture of PFA and PTFE).

The outer diameter in the center in the rotation axis direction of the second elastic layer 2c is set small as explained above. Therefore, an air gap (an air layer) is formed in the center and between the second elastic layer 2c and the metal conductive layer 2d.

In this embodiment, a radius r2 in the end position in the rotation axis direction of the second elastic layer 2c is set to 22.5 mm and a radius r1 in the center position in the rotation axis direction is set to 21.5 mm to form an air gap of 1 mm between the second elastic layer 2c and the metal conductive layer 2d in the center of the heating roller 2.

Since the heating roller 2 has the structure including the air gap in this way, a rise in the surface hardness of the heating roller 2 due to the thermal expansion of the first elastic layer 2b and the second elastic layer 2c can be suppressed when the heating roller 2 is heated and the temperature thereof rises. The suppression of the rise in the surface hardness can contribute to securing of appropriate nip width.

In this embodiment, the second elastic layer 2c among the plural elastic layer is formed to have the thickness of the center in the rotation axis direction smaller than that of the other portions. However, the present invention is not always limited to this. An effect same as that of the heating roller 2 according to this embodiment can be realized as long as a recess having small thickness of the center is provided in any one of the plural elastic layers.

When the second elastic layer 2c is not provided, the first elastic layer 2b, the metal conductive layer 2d, the third elastic layer 2e, and the release layer 2f have most of the heat capacity of the heating roller 2.

When continuous printing operation is performed in a machine having high printing speed, the number of sheets that pass a fixing device per unit time increases. Therefore, energy consumption by the passing sheets and toners also increases. The temperature on the roller surfaces of the heating roller 2 and the pressing roller 3 tends to fall.

In order to prevent deterioration in fixing performance due to such a temperature fall, it is necessary to increase the heat capacity of the entire heating roller 2 and increase an energy storage amount.

However, when the thickness of the metal conductive layer 2d, the third elastic layer 2e, and the release layer 2f is increased to increase the heat capacity thereof, this leads to a rise in the hardness of the roller surface. Therefore, it is hard to say that the increase in the thickness is preferable. When the thickness of the third elastic layer 2e and the release layer 2f located further on the outer circumferential side in the rotation radius direction than the metal conductive layer 2d as a heat generating layer increases, thermal resistance increases. Therefore, responsiveness of the temperature of the roller surface is deteriorated.

Therefore, in this embodiment, the second elastic layer 2c is provided to store heat in the second elastic layer 2c and suppress the fall in the surface temperature of the heating roller 2 during continuous paper feed to realize improvement of a fixing quality.

In this embodiment, the solid silicon rubber having thickness of 1.5 mm obtained by molding a material same as that of the first elastic layer 2b without causing the material to foam is adopted as the material of the second elastic layer 2c. This makes it possible to prevent a fixing failure due to the temperature fall of the roller surface during continuous paper feed or the like, although warming-up time in the fixing device 1 is slightly extended.

The first elastic layer 2b and the second elastic layer 2c (the plural elastic layers located between the core 2a and the metal conductive layer 2d) included in the heating roller 2 according to this embodiment are bonded to each other on the entire surfaces thereof.

On the other hand, the second elastic layer 2c (the elastic layer located on the outermost side in the rotation radius direction among the plural elastic layers located between the core 2a and the metal conductive layer 2d) and the metal conductive layer 2d are bonded to each other only near both the ends in the rotation axis direction.

By adopting such a configuration, it is possible to suppress an increase in the surface hardness of the heating roller 2 when the second elastic layer 2c bonded to the metal conductive layer 2d thermally expands. Further, it is possible to maintain proper width as the nip width of the nip formed by the heating roller 2 and the pressing roller 3.

### Second Embodiment

A second embodiment of the present invention is explained below.

This embodiment is a modification of the first embodiment explained above. In the following explanation, components having functions same as those of the components already explained in the first embodiment are denoted by the same reference numerals and signs and explanation of the components is omitted.

It is preferable to form the first elastic layer 2b, the second elastic layer 2c, and the third elastic layer 2e (the plural elastic layers) such that, in the rotation radius direction, the elastic layer on the outer side has specific heat (or specific gravity) larger than that of the elastic layer on the inner side and the elastic layer on the inner side has thermal conductivity lower than that of the elastic layer on the outer side.

In this way, the elastic layer located on the inner side in the rotation radius direction is formed to have heat insulating properties higher than those of the elastic layer located on the outer side in the rotation radius direction. This makes it possible to suppress heat from being deprived via the core 2a.

It goes without saying that, by using the same materials having different foaming ratios for the first elastic layer 2b, the second elastic layer 2c, and the third elastic layer 2e instead of simply using the different materials for the respective elastic layers, it is possible to show functions same as those realized when the different materials are used.

### Third Embodiment

A third embodiment of the present invention is explained below.

This embodiment is a modification of the embodiments explained above. In the following explanation, components having functions same as those of the components already explained in the embodiments are denoted by the same reference numerals and signs and explanation of the components is omitted.

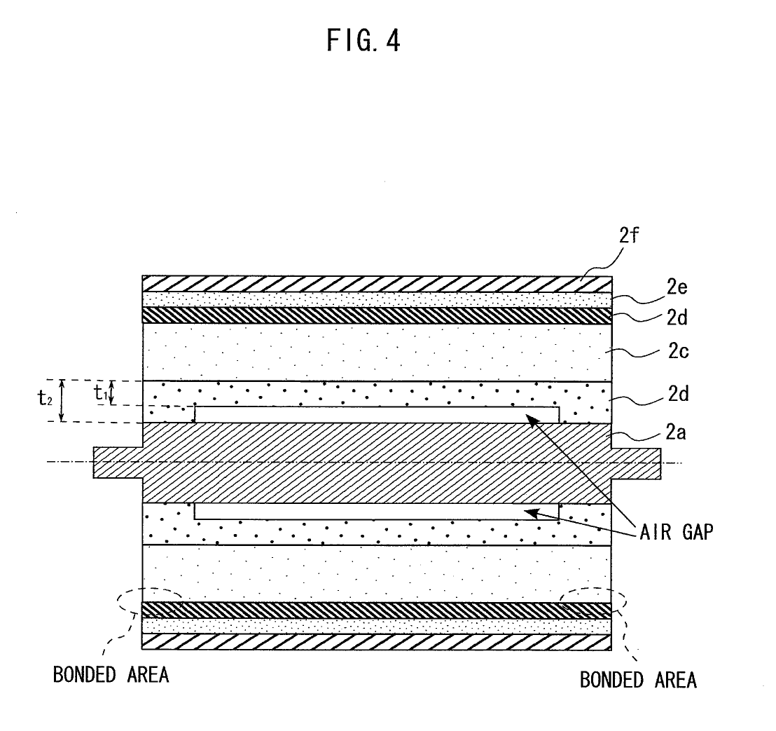

FIG. 4 is a sectional view of a configuration of a fixing device and a heating roller included in an image forming apparatus including the fixing device according to the third embodiment.

In this embodiment, the first elastic layer 2b located on the innermost side in the rotation radius direction among the first elastic layer 2b, the second elastic layer 2c, and the third elastic layer 2e (the plural elastic layers) is formed to have the thickness of the center in the rotation axis direction (thickness t1 in FIG. 4) smaller than the thickness of the other portions (thickness t2 in FIG. 4).

By adopting such a configuration, it is possible to suppress hardening of the heating roller surface when the first elastic layer 2b, the second elastic layer 2c, and the third elastic layer 2e thermally expands. The first elastic layer 2b is formed not to directly set in contact with the core 2a near the center in the rotation axis direction of the first elastic layer 2b. This makes it possible to reduce the shift of heat from the first elastic layer 2b to the core 2a as much as possible and contribute to stabilization of the temperature of the heating roller 2.

In the embodiments explained above, it is also possible to improve heat retaining properties and further improve the fixing performance by forming the second elastic layer 2c with larger thickness. However, since heat energy is excessively accumulated when the second elastic layer 2c is formed excessively thick, it is preferable to form the second elastic layer 2c with appropriate thickness.

In the example explained in the embodiments, the two elastic layers are located between the core 2a and the metal conductive layer 2d. However, the present invention is not always limited to this. It goes without saying that three or more elastic layers can be laminated.

In the example explained in the embodiments, the air gap is the air layer. However, the present invention is not always limited to this. A material that can show heat insulating performance without hindering the suppression of the increase in the surface hardness of the heating roller 2 may be filled in the air gap.

With the configuration explained above, the plural elastic layers are formed and the heat storage function is imparted to the elastic layers. This makes it possible to increase a heat capacity while maintaining the performance necessary for high-speed fixing such as the roller hardness and improve the performance of the fixing processing.

The present invention can be carried out in other various forms without departing from the spirit and the main characteristics of the present invention. Therefore, the embodiments are merely exemplary in every aspect and should not be limitedly interpreted. The scope of the present invention is indicated by patent claims and is not bound by the text of the specification at all. All variations, various improvements, alterations, and modifications belonging to the scope of equivalents of patent claims are within the scope of the present invention.

As explained above in detail, according to the present invention, it is possible to provide a technique that can contribute to the improvement of the fixing performance while maintaining appropriate nip width.

What is claimed is:

1. A heating roller comprising:
a core configured to rotate around a predetermined rotation axis;
plural elastic layers laminated on an outer circumference of the core; and
a conductive layer formed on an outer circumference of the plural elastic layers, wherein
the plural elastic layers have, in a rotation radius direction, larger specific heat in the elastic layer on an outer side than in the elastic layer on an inner side and have lower thermal conductivity in the elastic layer on the inner side than in the elastic layer on the outer side.

2. The roller according to claim 1, wherein the plural elastic layers have, in the rotation radius direction, higher hardness in the elastic layer on the outer side than in the elastic layer on the inner side.

3. The roller according to claim 1, wherein the plural elastic layers have, in the rotation radius direction, higher density in the elastic layer on the outer side than in the elastic layer on the inner side.

4. The roller according to claim 1, wherein any one of the plural elastic layers has thickness of a center in a direction of the rotation axis thinner than that of other portions.

5. The roller according to claim 1, wherein the elastic layer located on an innermost side in the rotation radius direction among the plural elastic layers has thickness of a center in a direction of the rotation axis thinner than that of other portions.

6. The roller according to claim 1, wherein
the plural elastic layers are bonded to one another on entire surfaces thereof, and
the elastic layer located on an outermost side in the rotation radius direction among the plural elastic layers and the conductive layer are bonded to each other only near both ends in a direction of the rotation axis.

7. The roller according to claim 1, wherein the elastic layer located on an innermost side in the rotation radius direction among the plural elastic layers is formed of foaming silicon rubber.

8. The roller according to claim 1, wherein the elastic layer located on an outermost side in the rotation radius direction among the plural elastic layers is formed of solid silicon rubber.

9. The roller according to claim 1, wherein the elastic layer located on an outermost side in the rotation radius direction among the plural elastic layers is formed of silicon rubber containing a filler such as carbon and/or metal.

10. The roller according to claim 1, wherein the elastic layer located on an outermost side in the rotation radius direction among the plural elastic layers is formed of foaming silicon rubber having a foaming ratio lower than that of the elastic layer located further on an inner side in the rotation radius direction than the elastic layer located on the outermost side in the rotation radius direction.

11. An image forming apparatus comprising:
a heating roller including:
a core configured to rotate around a predetermined rotation axis;
plural elastic layers laminated on an outer circumference of the core, the plural elastic layers having, in a rotation radius direction, larger specific heat in the elastic layer on an outer side than in the elastic layer on an inner side and having lower thermal conductivity in the elastic layer on the inner side than in the elastic layer on the outer side; and
a conductive layer formed on an outer circumference of the plural elastic layers;
a pressing roller configured to nip and carry a sheet having a toner image formed thereon and heat and fix the toner image on the sheet in cooperation with the heating roller; and
a discharge roller configured to discharge the sheet having the toner image heated and fixed thereon to a predetermined discharge position.

12. The apparatus according to claim 11, wherein the plural elastic layers have, in the rotation radius direction, higher hardness in the elastic layer on the outer side than in the elastic layer on the inner side.

13. The apparatus according to claim 11, wherein the plural elastic layers have, in the rotation radius direction, higher density in the elastic layer on the outer side than in the elastic layer on the inner side.

14. The apparatus according to claim 11, wherein any one of the plural elastic layers has thickness of a center in a direction of the rotation axis thinner than that of other portions.

15. The apparatus according to claim 11, wherein the elastic layer located on an innermost side in the rotation radius direction among the plural elastic layers has thickness of a center in a direction of the rotation axis thinner than that of other portions.

16. The apparatus according to claim 11, wherein
the plural elastic layers are bonded to one another on entire surfaces thereof, and
the elastic layer located on an outermost side in the rotation radius direction among the plural elastic layers and the conductive layer are bonded to each other only near both ends in a direction of the rotation axis.

17. The apparatus according to claim 11, wherein the elastic layer located on an innermost side in the rotation radius direction among the plural elastic layers is formed of foaming silicon rubber.

18. The apparatus according to claim 11, wherein the elastic layer located on an outermost side in the rotation radius direction among the plural elastic layers is formed of solid silicon rubber.

19. The apparatus according to claim 11, wherein the elastic layer located on an outermost side in the rotation radius direction among the plural elastic layers is formed of silicon rubber containing a filler such as carbon and/or metal.

20. A heating roller comprising:
a core configured to rotate around a predetermined rotation axis;
plural elastic layers laminated on an outer circumference of the core, the plural elastic layers having, in a rotation radius direction, larger specific heat in the elastic layer on an outer side than in the elastic layer on an inner side and having lower thermal conductivity in the elastic layer on the inner side than in the elastic layer on the outer side; and
a conductive layer formed on an outer circumference of the plural elastic layers.
